(19) United States
(12) Patent Application Publication
(10) Pub. No.: US 2007/0002242 A1
(43) Pub. Date: Jan. 4, 2007

(54) Liquid crystal display panel and method of correcting pixel defect

(75) Inventor: Tomohiro Ogata, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/366,539

(22) Filed: Mar. 3, 2006

(30) Foreign Application Priority Data
Jun. 29, 2005 (JP) JP2005-189288

(51) Int. Cl. G02F 1/1343

(52) U.S. Cl. 349/139

(57) ABSTRACT

A pixel electrode arranged opposite to a counter electrode with liquid crystal filled in therebetween has a plurality of through holes spaced from one another. When a foreign substance adheres to the pixel electrode, the pixel electrode is partly removed to connect some of the through holes to each other, so that a portion to which the foreign substance adheres is removed from the pixel electrode. Accordingly, when a conductive foreign substance adheres to the pixel electrode, an electric contact between the pixel electrode and counter electrode can be avoided while making smaller a portion to be removed from the pixel electrode. Therefore, even when electrode pieces occur when partly removing the pixel electrode, the electrode pieces can be reduced in amount and prevented from being adhered to the surroundings. As a result, the occurrence of another pixel defect can be suppressed.

### BACKGROUND OF THE INVENTION

1. Field of the Invention

The present invention relates to a liquid crystal display panel and a method of correcting a pixel defect.

2. Description of the Background Art

A liquid crystal display panel has, for example, a TFT array substrate on which a plurality of thin film transistors (TFTs), a pixel electrode and the like are formed and a substrate on which a counter electrode is formed, and these substrates are arranged opposite to each other at a certain distance. Liquid crystal is filled in between these substrates. Through application of voltage to the liquid crystal, the transmittance of light transmitted through the liquid crystal display panel varies. In such liquid crystal display panel, a conductive foreign substance, if any, between the pixel electrode and counter electrode may cause the pixel electrode and counter electrode to be electrically connected to each other. As a result, application of voltage to the pixel electrode through the TFTs will bring the pixel electrode and counter electrode into the same potential. In such case, a bright-spot defect occurs in a normally-white liquid crystal display panel.

A method of correcting a bright-spot defect is disclosed in Japanese Patent Application Laid-Open No. 8-286208 (1996). The technique disclosed in this document applies laser irradiation to partly break a pixel electrode in the vicinity of a foreign substance, to thereby electrically isolate the pixel electrode and counter electrode from each other to correct a bright-spot defect.

However, the pixel electrode is partly broken in the vicinity of a foreign substance by laser irradiation with the technique disclosed in the aforementioned JP8-286208, so that scattered pieces of the pixel electrode may be adhered to another pixel electrode and the like in a neighboring normal pixel, which may cause another bright-spot defect.

Further, laser is also irradiated onto liquid crystal around the foreign substance, which may bring the orientation of liquid crystal into out of order. In such case, a laser-irradiated portion of liquid crystal may be turned into a bright spot, which may be recognized by a viewer.

### SUMMARY OF THE INVENTION

An object of the present invention is to provide a technique capable of avoiding a pixel defect in a liquid crystal display panel.

According to a first aspect of the invention, the liquid crystal display panel includes a pixel electrode having a plurality of through holes spaced from one another; and a counter electrode arranged opposite to the pixel electrode with liquid crystal provided therebetween.

When a foreign substance adheres to the pixel electrode, the pixel electrode is partly removed to connect through holes to each other, so that a portion to which the foreign substance adheres on the pixel electrode can be removed from the pixel electrode. Accordingly, even when a conductive foreign substance adheres to the pixel electrode, an electric contact between the pixel electrode and counter electrode can be avoided while making smaller a portion to be removed from the pixel electrode. Therefore, even when electrode pieces occur when partly removing the pixel electrode, the electrode pieces can be reduced in amount and prevented from being adhered to the surroundings. As a result, the occurrence of another pixel defect can be suppressed.

According to a second aspect of the invention, a method of correcting a pixel defect includes the steps (a) and (b). The step (a) is to prepare a liquid crystal display panel including a pixel electrode and a counter electrode arranged opposite to the pixel electrode, the pixel electrode having a plurality of through holes spaced from one another. The step (b) is to partly remove the pixel electrode, when a foreign substance adheres to the pixel electrode, to connect at least two of the plurality of through holes to each other, thereby removing a portion of the pixel electrode to which the foreign substance adheres, from the pixel electrode.

When a foreign substance adheres to the pixel electrode, the pixel electrode is partly removed to connect through holes to each other, so that a portion to which the foreign substance adheres on the pixel electrode is removed from the pixel electrode. Accordingly, even when a conductive foreign substance adheres to the pixel electrode, an electric contact between the pixel electrode and counter electrode can be avoided while making smaller a portion to be removed from the pixel electrode. Therefore, even when electrode pieces occur when partly removing the pixel electrode, the electrode pieces can be reduced in amount and prevented from being adhered to the surroundings. As a result, the occurrence of another pixel defect can be suppressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a partial plan view showing the structure of a liquid crystal display panel according to a preferred embodiment of the present invention;

FIG. 2 is a partial sectional view showing the structure of the liquid crystal display panel according to the preferred embodiment of the invention;

FIGS. 3 through 8 are diagrams showing a method of correcting a pixel defect according to the preferred embodiment of the invention; and

FIG. 9 is a diagram showing a variation of the method of correcting a pixel defect according to the preferred embodiment of the invention.

### DESCRIPTION OF THE PREFERRED EMBODIMENTS

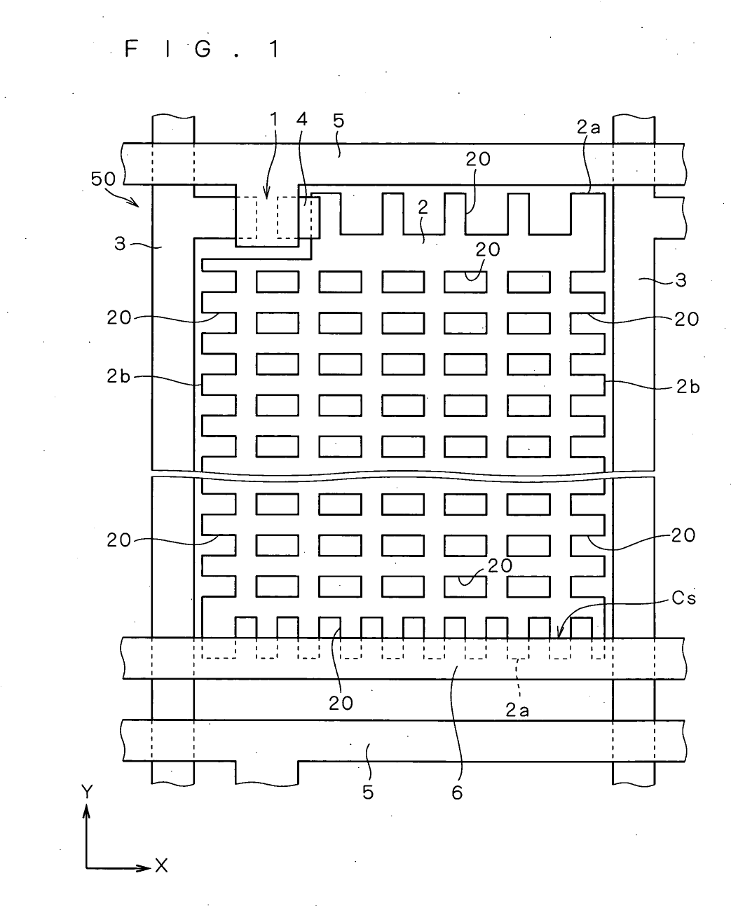

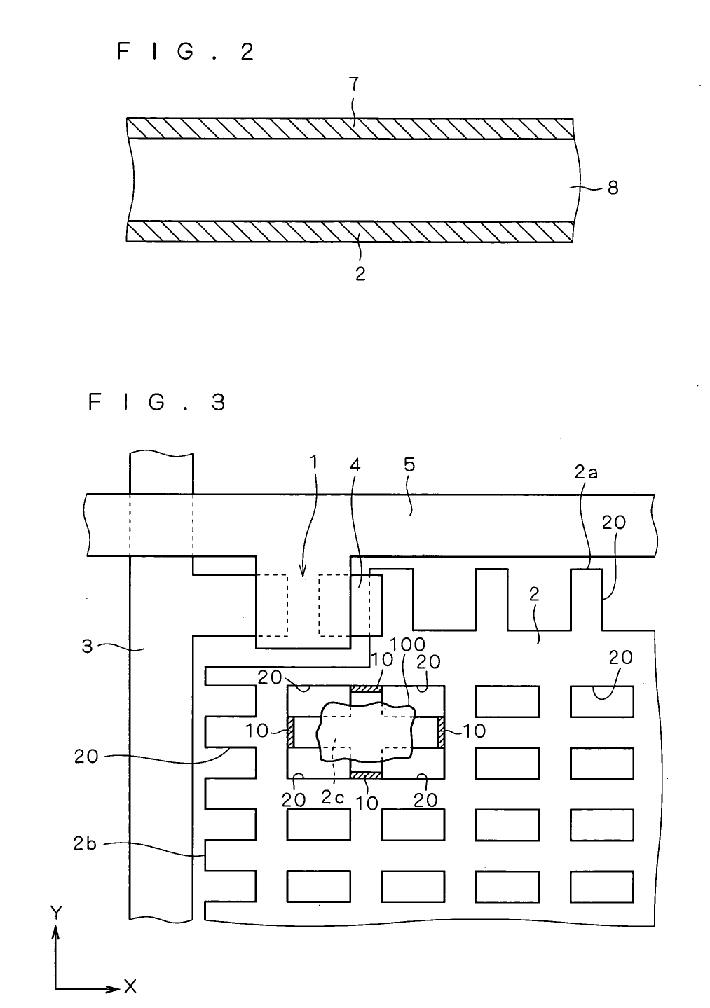

FIGS. 1 and 2 are a partial plan view and a partial sectional view, respectively showing the structure of a liquid crystal display panel according to a preferred embodiment of the present invention. The liquid crystal display panel of the present embodiment is a normally-white liquid crystal display panel, by way of example, and is provided with a plurality of pixel structures 50 arranged in a matrix. FIG. 1 shows only one of the plurality of pixel structures 50. As shown in FIG. 1, a pixel structure 50 of the liquid crystal display panel of the present embodiment includes a thin film transistor 1, a pixel electrode 2, a source interconnect line 3 extending in a column direction Y, a drain interconnect line 4, a gate interconnect line 5 extending in a row direction X and a storage capacity interconnect line 6 also extending in the row direction X, which are formed on a substrate not shown such as a glass substrate.

The thin film transistor 1 is, for example, a positive-staggered a-Si (amorphous-silicon) TFT. The source interconnect line 3 is connected to a source region (not shown) of the thin film transistor 1. The drain interconnect line 4 has its one end connected to a drain region (not shown) of the thin film transistor 1 and the other end connected to the pixel electrode 2. The gate interconnect line 5 serves as a gate electrode of the thin film transistor 1, and is provided above part of the source interconnect line 3 and above part of the drain interconnect line 4.

The pixel electrode 2 has a plurality of through holes 20 extending through its entire thickness which are spaced from one another. The plurality of through holes 20 are each in the shape of square pole, and are arrayed in a matrix except on the opposite edges of the pixel electrode 2 in the column direction Y. Those of the plurality of through holes 20 on the opposite edges of the pixel electrode 2 in the column direction Y are formed in the row direction X at uniform intervals, providing opposite edge surfaces 2a of the pixel electrode 2 in the column direction Y with projections and depressions. Similarly, those of the plurality of through holes 20 on the opposite edges of the pixel electrode 2 in the row direction X are formed in the column direction Y, providing both edge surfaces 2b of the pixel electrode 2 in the row direction X with projections and depressions. The through holes 20 are not limited to the shape of square pole, but may be in the shape of triangle pole, pentagonal pole or cylinder.

The storage capacity interconnect line 6 is formed on one edge of the pixel electrode 2 in the column direction Y with an insulation film not shown but interposed therebetween, to create a storage capacitance Cs together with that insulation film and pixel electrode 2.

The liquid crystal display panel according to the present embodiment further has a counter electrode 7 at a certain distance from the pixel electrode 2 as shown in FIG. 2. Crystal liquid 8 is filled in between the pixel electrode 2 and counter electrode 7. The counter electrode 7 is formed on a substrate not shown such as a glass substrate.

In the liquid crystal display panel of the above structure, a predetermined voltage is applied to the gate interconnect line 5 to bring the thin film transistor 1 serving as a switching element into ON state. Then, a driving voltage applied to the source interconnect line 3 is applied to the pixel electrode 2 through the drain interconnect line 4. On the other hand, a predetermined voltage is also applied to the counter electrode 7 arranged opposite to the pixel electrode 2. This, as a result, creates a voltage difference between the pixel electrode 2 and counter electrode 7, and an electric field is applied to the liquid crystal 8 filled in therebetween. Accordingly, the transmittance of light transmitted through the liquid crystal display panel of the present embodiment varies. The driving voltage applied to the pixel electrode 2 is accumulated at the storage capacitance Cs, so that a driving voltage is applied to the pixel electrode 2 even when the thin film transistor 1 is in the OFF state.

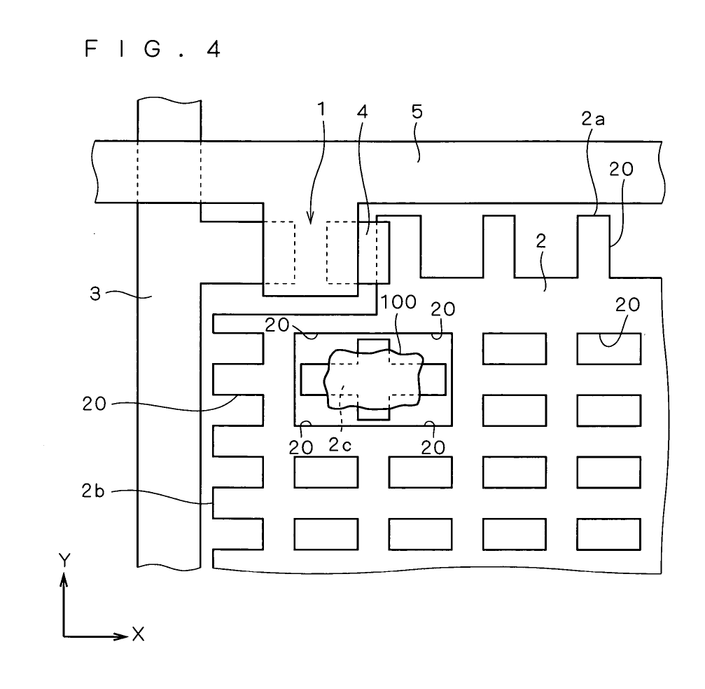

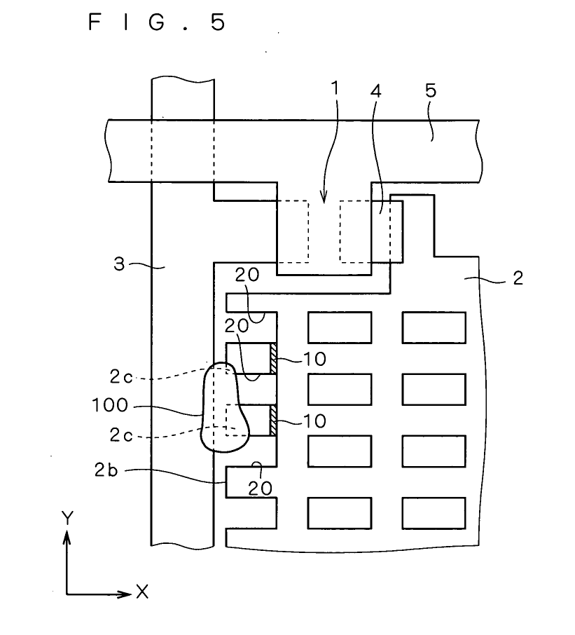

Now, a method of correcting a pixel defect occurring when a foreign substance is adhered to the pixel electrode 2 is described. FIG. 3 is a plan view showing a method of correcting a pixel defect according to the present embodiment. FIG. 3 and FIGS. 4 through 9 which will be described later are enlarged views partially showing the pixel structure 50 shown in FIG. 1. As shown in FIG. 3, when a foreign substance 100 is adhered to the pixel electrode 2, the pixel electrode 2 is partly removed to connect at least two through holes 20 to each other, so that a portion 2c to which the foreign substance 100 adheres on the pixel electrode 2 (hereinafter referred to as a foreign-substance-adhered portion 2c) is removed from the pixel electrode 2. The removal of the foreign-substance-adhered portion 2c from the pixel electrode 2 is achieved by, for example, irradiating laser onto a portion to be removed. In the example shown in FIG. 3, to-be-removed portions 10 defined around the foreign-substance-adhered portion 2c are irradiated with laser and removed. Accordingly, as shown in FIG. 4, four through holes 20 adjacent to the foreign-substance-adhered portion 2c are connected to one another, so that the foreign-substance-adhered portion 2c is removed from the pixel electrode 2.

The removal of the foreign-substance-adhered portion 2c from the pixel electrode 2 in this way can avoid an electric contact between the pixel electrode 2 and counter electrode 7 even when the conductive foreign substance 100 adheres to the pixel electrode 2, and the normally-white liquid crystal display panel can prevent the occurrence of bright-spot defect.

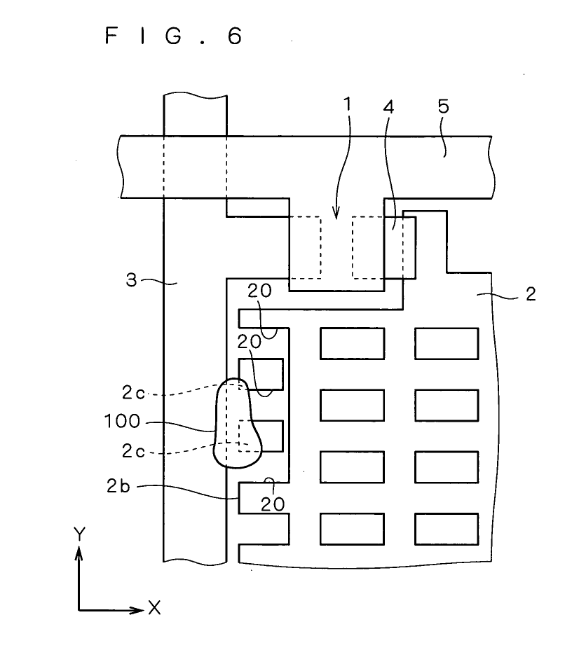

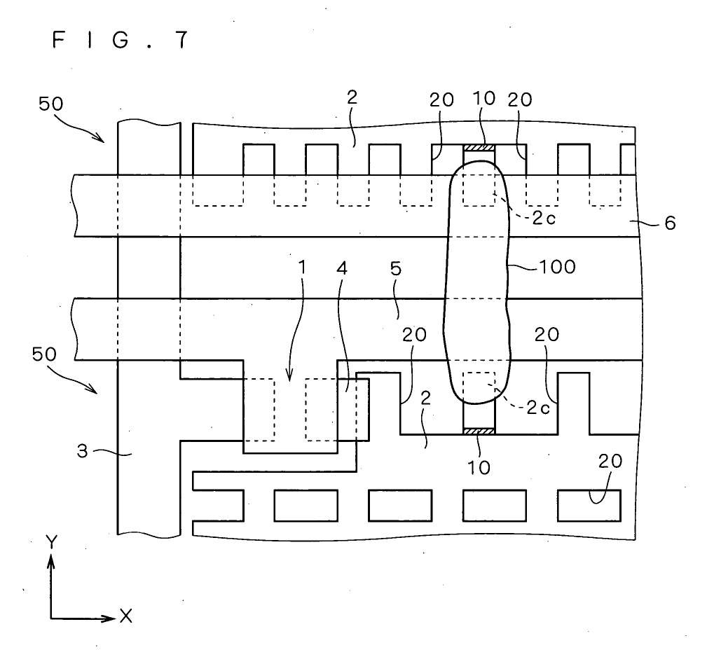

Even when the foreign substance 100 adheres to straddle an interconnect line such as the source interconnect line 3 and the pixel electrode 2, the foreign-substance-adhered portion 2c can similarly be removed from the pixel electrode 2 by removing part of the pixel electrode 2 to connect a plurality of through holes 20 to one another. FIG. 5 is a plan view showing a method of correcting a pixel defect in the case where the foreign substance 100 adheres to straddle the source interconnect line 3 and pixel electrode 2. In this example, similarly to the example shown in FIG. 3, the to-be-removed portion 10 defined around the foreign-substance-adhered portion 2c is irradiated with laser and removed. Accordingly, as shown in FIG. 6, a plurality of through holes 20 adjacent to the foreign-substance-adhered portion 2c are connected to one another, so that the foreign-substance-adhered portion 2c is removed from the pixel electrode 2. Therefore, even when the conductive foreign substance 100 adheres to straddle the source interconnect line 3 and pixel electrode 2, an electric contact between the pixel electrode 2 and counter electrode 7 can be avoided, and an electric contact between the pixel electrode 2 and source interconnect line 3 can be avoided.

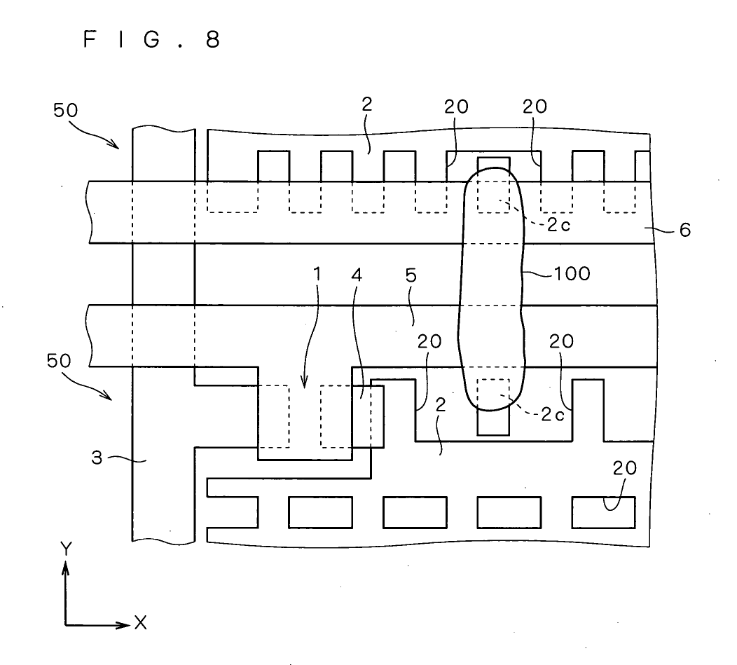

Even when the foreign substance 100 adheres to straddle pixel electrodes 2 of two pixel structures 50 adjacent to each other, the foreign-substance-adhered portion 2c can similarly be removed from the pixel electrode 2 in each of the two pixel structures 50. FIG. 7 is a plan view showing a method of correcting a pixel defect in the case where the foreign substance 100 adheres to both two pixel structures 50 adjacent to each other. In the example shown in FIG. 7, the foreign substance 100 adheres to straddle two pixel structures 50 adjacent to each other in the column direction Y. In the upper pixel structure 50 shown in FIG. 7, the foreign substance 100 adheres to straddle the storage capacity interconnect line 6 and pixel electrode 2. In the lower pixel structure 50, the foreign substance 100 adheres to straddle the gate interconnect line 5 and pixel electrode 2.

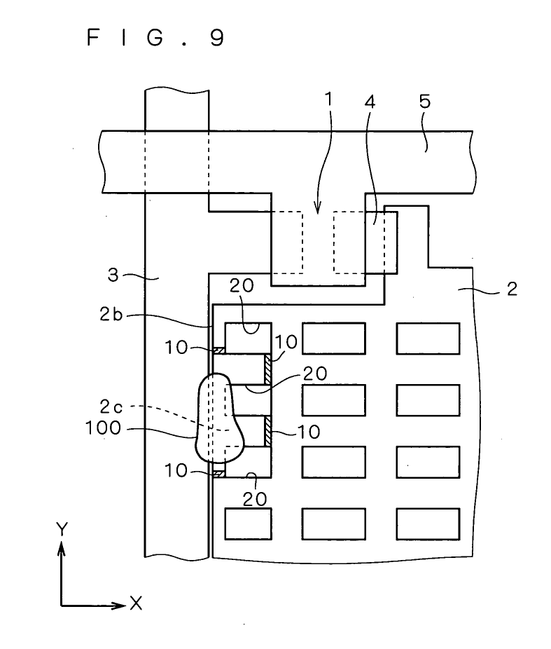

In this example, the to-be-removed portion 10 defined around the foreign-substance-adhered portion 2c of each of the upper and lower pixel structures 50 is irradiated with laser and removed. Accordingly, as shown in FIG. 8, in the upper pixel structure 50, two through holes 20 adjacent to the foreign-substance-adhered portion 2c are connected to each other, so that the foreign-substance-adhered portion 2c is removed from the pixel electrode 2. Similarly, in the lower pixel structure 50, two through holes 20 adjacent to the foreign-substance-adhered portion 2c are connected to each other, so that the foreign-substance-adhered portion 2c is removed from the pixel electrode 2. Therefore, even when the conductive foreign substance 100 adheres to straddle two pixel structures 50, an electric contact between the pixel electrode 2 and counter electrode 7 in each of the pixel structures 50 can be avoided, and an electric contact between the pixel electrodes 2 of the two pixel structures 50 adjacent to each other can be avoided.

The laser irradiation onto the to-be-removed portion 10 may be conducted from and through a substrate on which the counter electrode 7 and the like are formed, or may be conducted from and through a substrate on which the pixel electrode 2 and the like are formed.

As described, in the liquid crystal display panel according to the present embodiment, the pixel electrode 2 are provided with a plurality of through holes 20. When the foreign substance 100 adheres to the pixel electrode 2, the pixel electrode 2 is partly removed to connect at least two through holes 20 to each other, so that the foreign-substance-adhered portion 2c can be removed from the pixel electrode 2. Therefore, an electric contact between the pixel electrode 2 and counter electrode 7 can be avoided while making a to-be-removed portion of the pixel electrode 2 smaller than in the technique disclosed in the aforementioned JP8-286208 which describes removing all of portions adjacent to a portion to which a foreign substance adheres. Thus, even when electrode pieces occur when partly removing the pixel electrode 2, such electrode pieces can be reduced in amount, and can be prevented from being adhered to neighboring normal pixel structures 50. As a result, the occurrence of another pixel defect can be suppressed.

Even when laser is applied to partly remove the pixel electrode 2, an area to be irradiated with laser in the pixel electrode 2 can be made smaller, so that an area to be irradiated with laser in the liquid crystal 8 between the pixel electrode 2 and counter electrode 7 can also be made smaller. Accordingly, the orientation of the liquid crystal 8 can be prevented from being disordered by laser irradiation, which thus can suppress the occurrence of another pixel defect.

Even when the conductive foreign substance 100 is adhered to straddle an interconnect line such as the source interconnect line 3 and the pixel electrode 2, a plurality of through holes 20 provided for the pixel electrode 2 are connected to one another so that the foreign-substance-adhered portion 2c can be removed from the pixel electrode 2. It is therefore not necessary to irradiate laser onto such interconnect line. This can avoid an electric contact between the pixel electrode 2 and the interconnect line without damaging the interconnect line. Particularly in the case where the storage capacity interconnect line 6 is irradiated with laser, the storage capacity interconnect line 6 and pixel electrode 2 may be shorted to each other, however, laser irradiation onto the storage capacity interconnect line 6 is not required in the present embodiment, and therefore, such problem can be avoided.

Even when the conductive foreign substance 100 adheres to straddle two adjacent pixel structures 50, a plurality of through holes 20 provided for the pixel electrode 2 of each of the pixel structures 50 are connected to one another to remove the foreign-substance-adhered portion 2c from the pixel electrode 2. Therefore, an electric contact between the pixel structures 50 can be avoided.

In the present embodiment, the plurality of through holes 20 are provided on the opposite edges of the pixel electrode 2 to provide projections and depressions for the opposite edge surfaces 2a and 2b of the pixel electrode 2. Accordingly, a portion to be removed from the pixel electrode 2 when the foreign substance 100 adheres to the edges of the pixel electrode 2 can be made smaller. The effects of this advantage are described below in detail.

FIG. 9 is a plan view showing a method of correcting a pixel defect in the case where an edge surface 2b of the pixel electrode 2 is flat without any projection or depression, and all the through holes 20 are enclosed within the pixel electrode 2. In the case where the edge surface 2b of the pixel electrode 2 is flat as shown in FIG. 9, when the foreign substance 100 adheres to the edges of the pixel electrode 2 including the edge surface 2b , portions connecting the edge surface 2b and through holes 20 of the pixel electrode 2 also need to be included in the to-be-removed portions 10 in order to remove the foreign-substance-adhered portion 2c from the pixel electrode 2. Therefore, in this case, a portion to be removed from the pixel electrode 2 increases in area, which in turn increases the possibility that electrode pieces occurring when partly removing the pixel electrode 2 adhere to an adjacent pixel structure 50.

On the other hand, in the case where the edge surface 2b of the pixel electrode 2 has projections and depressions as described in the present embodiment, the aforementioned portions connecting the edge surface 2b and through holes 20 of the pixel electrode 2 do not exist, as shown in FIG. 5. Therefore, a portion to be removed from the pixel electrode 2 can be made smaller than in the case shown in FIG. 9.

In this way, when the edge surfaces 2a and 2b of the pixel electrode 2 have projections and depressions, a portion to be removed from the pixel electrode 2 can be made smaller. Accordingly, even in the case where electrode pieces occur when partly removing the pixel electrode 2, such electrode pieces can be reduced in amount. Therefore, such electrode pieces become less likely to be adhered to the surroundings, which can suppress the occurrence of another pixel defect.

Further, as described in the present embodiment, in the case where the plurality of through holes 20 are provided in the entire surface of the pixel electrode 2, the foreign-substance-adhered portion 2c can be removed from the pixel electrode 2 while making smaller the portion to be removed from the pixel electrode 2 regardless of where on the pixel electrode 2 the foreign substance 100 adheres. This, in turn, ensures that the occurrence of still another pixel defect is suppressed.

Furthermore, in the method of correcting a pixel defect according to the present embodiment, the pixel electrode 2 is partly removed when the foreign substance 100 adheres to the pixel electrode 2, to connect at least two through holes 20 to each other, so that the foreign-substance-adhered portion 2c is removed from the pixel electrode 2. Accordingly, even when the conductive foreign substance 100 adheres to the pixel electrode 2, an electric connection between the pixel electrode 2 and counter electrode 7 can be avoided while making smaller a portion to be removed from the pixel electrode 2. Therefore, even when electrode pieces occur when partly removing the pixel electrode 2, the electrode pieces can be reduced in amount and prevented from being adhered to neighboring normal pixel structures 50. This, in turn, can suppress the occurrence of another pixel defect.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display panel comprising:
a pixel electrode having a plurality of through holes spaced from one another; and
a counter electrode arranged opposite to said pixel electrode with liquid crystal provided therebetween.

2. The liquid crystal display panel according to claim 1, wherein
said plurality of through holes are provided at least on an edge of said pixel electrode such that said pixel electrode has an edge surface provided with projections and depressions.

3. The liquid crystal display panel according to claim 1, wherein
said plurality of through holes are provided in an entire surface of said pixel electrode.

4. A method of correcting a pixel defect, comprising the steps of:
(a) preparing a liquid crystal display panel including a pixel electrode and a counter electrode arranged opposite to said pixel electrode with liquid crystal provided therebetween, said pixel electrode having a plurality of through holes spaced from one another; and
(b) partly removing said pixel electrode, when a foreign substance adheres to said pixel electrode, to connect at least two of said plurality of through holes to each other, thereby removing a portion of said pixel electrode to which said foreign substance adheres, from said pixel electrode.
